(19) United States
(12) Patent Application Publication
(10) Pub. No.: US 2021/0405444 A1
(43) Pub. Date: Dec. 30, 2021

(54) DISPLAY PANEL, DISPLAY DEVICE AND DISPLAY PANEL MANUFACTURING METHOD

(71) Applicant: WUHAN CHINA STAR OPTOELECTRONICS TECHNOLOGY CO., LTD., Wuhan, Hubei (CN)

(72) Inventor: Qin LIU, Wuhan, Hubei (CN)

(21) Appl. No.: 16/631,714

(22) PCT Filed: Nov. 7, 2019
(86) PCT No.: PCT/CN2019/116141

§ 371 Date: Jan. 16, 2020

(30) Foreign Application Priority Data
Sep. 20, 2019 (CN) 201910891027.7

(51) Int. Cl. G02F 1/1335; C09J 9/02

(52) U.S. Cl. CPC G02F 1/133528; C08K 2003/0806; C08K 2201/001; C09J 9/02

(57) ABSTRACT

The present invention provides a display panel, a display device, and a display panel manufacturing method. The display panel includes a first substrate, a second substrate, a conductive adhesive layer, and a polarizer. The second substrate is disposed on the first substrate. The conductive adhesive layer is disposed on the first substrate adjacent to the second substrate. The polarizer is disposed on the second substrate and the conductive adhesive layer. The display device includes the display panel.

### FIELD OF INVENTION

The present invention relates to a field of displays, especially to a display panel, a display device and a display panel manufacturing method.

### BACKGROUND OF INVENTION

In a field of liquid crystal display technologies, liquid crystal display devices (LCDs) have advantages of light weight and thinness, low power consumption, and no radiation, and therefore are extensively applied to products such as televisions, laptops, mobile phones, and personal digital assistants.

With reference to FIG. 1, a conventional display panel 90 comprises an array substrate 91, a color substrate 92 disposed on the array substrate 91, and a polarizer 93 and a conductive adhesive layer 94 disposed on the color substrate 92. The conductive adhesive layer 94 is located adjacent to the polarizer 93. A material of a polarization layer 931 in the polarizer 93 is polyvinyl alcohol (PVA), which has polarization characteristics.

In designs of current products, the conductive adhesive layer 94 is made by vertically coated a silver paste, and a direction of vertically coating a silver paste is shown by an arrow in FIG. 1. Because the coated a silver paste is located a side of the polarizer 93, the silver paste contacts and reacts with the polarization layer of the polarizer 93, and gradually infiltrates polarization layer to form bubble lines, which finally results in failure of the polarizer 93.

### SUMMARY OF INVENTION

### Technical Issue

The present invention provides a display panel, a display device, and a display panel manufacturing method, which solve the technical issue that the conductive adhesive layer contacts the side of the polarizer and causes failure of the polarizer, and guarantee a yield rate of products.

Technical Solution

To achieve the above objective, the present invention provides a display panel comprising a first substrate, a second substrate, a conductive adhesive layer, and a polarizer. Specifically, the second substrate is disposed on the first substrate; the conductive adhesive layer is disposed on the first substrate, and is located adjacent to the second substrate; and the polarizer is disposed on the second substrate and the conductive adhesive layer.

Furthermore, a thickness of the conductive adhesive layer is equal to a thickness of the second substrate.

Furthermore, a sum of lengths of the second substrate and the conductive adhesive layer is less than a length of the first substrate.

Furthermore, material of the conductive adhesive layer comprises conductive adhesive including silver.

Furthermore, the polarizer completely covers the second substrate and the conductive adhesive layer.

Furthermore, the polarizer comprises a lower protective layer and a polarization layer stacked sequentially from bottom to top. Specifically, the polarization layer is disposed on the lower protective layer.

Furthermore, the polarizer further comprises an upper protective layer, and the upper protective layer is disposed on the polarization layer.

The present invention also provides a display panel manufacturing method, comprising steps as follows:

providing a first substrate, a second substrate, and a polarizer;

disposing the second substrate on the first substrate;

1 attaching the polarizer on the second substrate and the conductive adhesive layer; and

injecting a silver paste on the first substrate and on a side of the second substrate, wherein the silver paste is cured to form a conductive adhesive layer.

Furthermore, the conductive adhesive is made by a nozzle-printing process or an ink-printing process.

The present invention also provides a display device comprising the display panel as described above.

### Advantages

Advantages of the present invention are that the provided display panel, display device, and display panel manufacturing method dispose the conductive adhesive layer under the polarizer to avoid the conductive adhesive layer from contacting the side of the polarization layer to further prevent the injected a silver paste from interfering with the polarizer and causing bubbles before being cured and forming the conductive adhesive layer such that the silver paste is prevented from reacting with and corroding the polarization layer. The prevent invention solves the technical issue of contact between the conductive adhesive layer and the side of the polarizer causing failure of the polarizer and guarantees a yield rate of products.

### DESCRIPTION OF DRAWINGS

FIG. 1 is a schematic structural view of a conventional display panel;

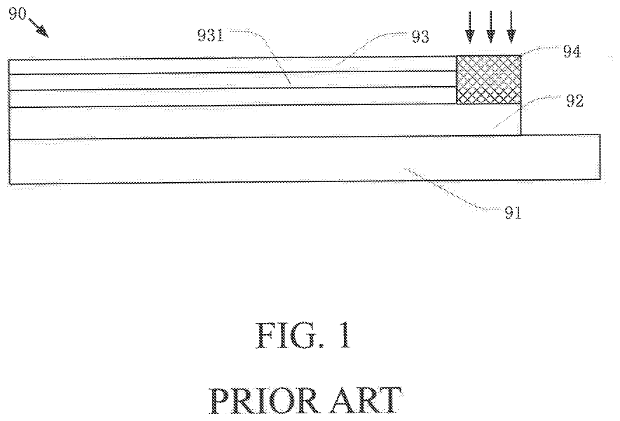

FIG. 2 is a schematic structural view of a display panel of the present invention; and

FIG. 3 is a flowchart of a display panel manufacturing method of an embodiment of the present invention.

Reference numerals in the drawings are as follows:

1 first substrate; 2 second substrate;

3 conductive adhesive layer; 4 polarizer;

41 lower protective layer; 42 polarization layer; 43 upper protective layer;

10 display panel.

### DETAILED DESCRIPTION OF PREFERRED EMBODIMENTS

The preferred embodiments of the present invention are described below with reference to the accompanying drawings, which are used to exemplify the embodiments of the present invention to a person of ordinary skill in the art to make the technical contents of the present invention clearer and easy to understand. However, the present invention may be embodied in many different forms of embodiments, and the scope of the invention is not limited to the embodiments mentioned herein.

The technical solution in the embodiment of the present invention will be clearly and completely described below with reference to the accompanying drawings in the embodiments of the present invention. Apparently, the described embodiments are merely some embodiments of the present invention instead of all embodiments. According to the embodiments in the present invention, all other embodiments obtained by those skilled in the art without making any creative effort shall fall within the protection scope of the present invention.

In the present invention, unless clear rules and limitations otherwise exist, terminologies “install”, “connect”, “connection” should be understood in a broad sense. For instance, the connection can be a fixed connection, a detachable connection or an integral connection. The connection can be a mechanical connection, an electrical connection or a telecommunication. The connection can be a direct connection, an indirect connection through an intermedium, can be an internal communication between two elements or an interaction between the two elements. For a person of ordinary skill in the art, the specific meaning of the above terminology in the present invention can be understood on a case-by-case basis.

The present invention provides a display device, and the display device comprises a display panel.

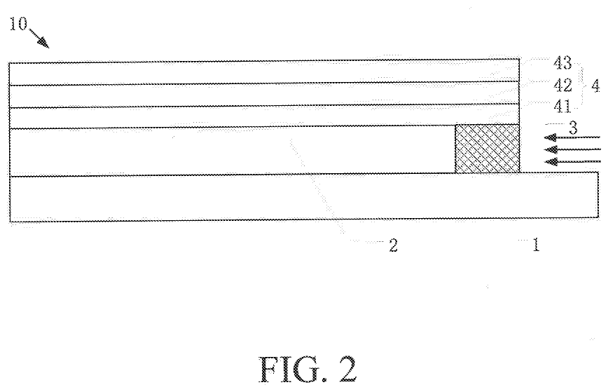

With reference to FIG. 2, the display panel 10 comprises a first substrate 1, a second substrate 2, a conductive adhesive layer 3, and a polarizer 4.

Specifically, the second substrate 2 is disposed on the first substrate 1. The conductive adhesive layer 3 is disposed on the first substrate 1, and is located adjacent to the second substrate 2. The polarizer 4 is disposed on the second substrate 2 and the conductive adhesive layer 3.

In the present embodiment, a thickness of the conductive adhesive layer 3 is equal to a thickness of the second substrate 2.

In the present embodiment, a sum of lengths of the second substrate 2 and the conductive adhesive layer 3 is less than a length of the first substrate 1.

In the present embodiment, material of the conductive adhesive layer 3 comprises conductive adhesive including silver.

In the present embodiment, the polarizer 4 completely covers the second substrate 2 and the conductive adhesive layer 3. Preferably, a length of the polarizer 4 is equal to the sum of the lengths of the second substrate 2 and the conductive adhesive layer 3. In other words, a side of the polarizer 4 is flush with the side of the second substrate 2 and a side of the conductive adhesive layer 3, which can assure that the conductive adhesive layer 3 is disposed under the polarization layer 42 to prevent the conductive adhesive layer 3 from contacting a side of the polarization layer 42 to further prevent contact of the conductive adhesive and polarization layer 42 causing corrosion of the polarizer 4. Therefore, the conductive adhesive is prevented from interfering with the polarizer 4 and causing bubbles, which solves the technical issue of the conductive adhesive layer 3 contacting the side of the polarizer 4 and causing failure of the polarizer 4 and guarantees a yield rate of products.

The first substrate 1 is an array substrate. The second substrate 2 is a color substrate. A liquid crystal layer (not shown in the figures) is disposed between the first substrate 1 and the second substrate 2.

In the present embodiment, the polarizer 4 functions to convert natural light without polarity into polarized light such that rotation of liquid crystal controls transmission of the polarized light to achieve bright and dark display effect of the liquid crystal display panel. The polarizer 4 comprises the lower protective layer 41 and the polarization layer 42 that are stacked each other from bottom to top. The polarization layer 42 is disposed on the lower protective layer 41.

In the present embodiment, the polarizer 4 further comprises an upper protective layer 43. The upper protective layer 43 is disposed on the polarization layer 42.

Material of the lower protective layer 41 and the upper protective layer 43 is triacetyl cellulose (TAC). The lower protective layer 41 is processed by a hard coating (HC) process to finally form a HC film on a surface of the conductive layer, which enhances hardness of a surface of the polarizer 4. The polarization layer 42 serves as a core film of the polarizer 4, and is disposed between the lower protective layer 41 and the upper protective layer 43. Material of the polarization layer 42 is polyvinyl alcohol (PVA) the polarization layer 42 has excellent transparency characteristics and has a polarization characteristics. The polarization layer 42 has excellent affinity with iodine molecules and has high orientation when stretched. The polyvinyl alcohol is highly water soluble and therefore the polarization layer 42 has weak waterproof characteristics. Thus, the lower protective layer 41 and the upper protective layer 43 have waterproof characteristics to protect the polarization layer 42.

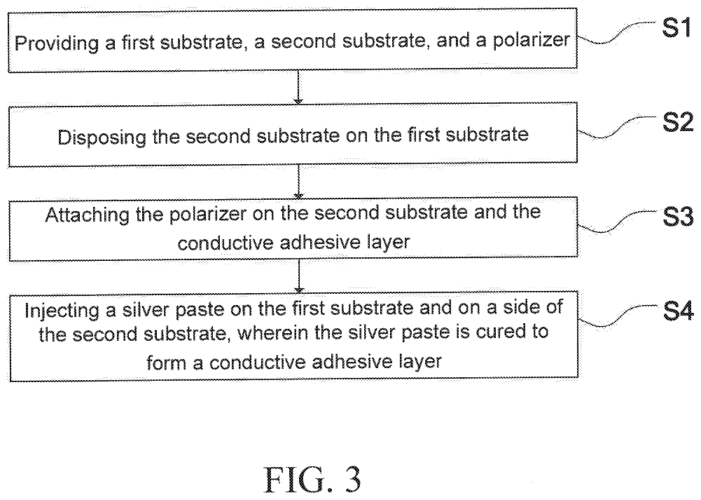

With reference to FIG. 3, the present invention also provides a manufacturing method for the display panel 10, comprising steps S1 to S4 as follows.

The step S1 comprises providing a first substrate 1, a second substrate 2, and a polarizer 4.

The step S2 comprises disposing the second substrate 2 on the first substrate 1.

The step S3 comprises attaching the polarizer 4 on the second substrate 2 and the conductive adhesive layer 3.

The step S4 comprises injecting a silver paste on the first substrate 1 and on a side of the second substrate 2, and the silver paste is cured to form a conductive adhesive layer 3.

The way of the manufacturing method injecting the silver paste is changed from vertically coating into horizontally side-injection, and a direction of horizontally side-injecting the silver paste is indicated by an arrow in FIG. 2. Thus, the conductive adhesive and the polarizer 4 exceed and extend out of a lower surface of the second substrate 2, and the side of the second substrate 2 fully contacts an upper surface of the first substrate 1, which not only guarantees fixing tightness of the conductive adhesive cured to form the conductive adhesive layer 3, but also prevents the conductive adhesive from contacting the side of the polarizer 4 to further prevent the conductive adhesive from interfering with the polarizer 4 and generating bubbles. Therefore, the issue of the conductive adhesive reacting with the polarization layer 42 and causing corrosion of the polarizer 4 is prevented.

In the above two embodiments, an optical clear adhesive (OCA) layer is attached to the polarizer 4 and the second substrate 2.

The conductive adhesive is made by a nozzle-printing process or an ink-printing process. The nozzle-printing process or the ink-printing process is an inkjet-printing process. The inkjet-printing process is a non-contact process, which can improve contact pollution of a functional solution. Employment of the inkjet-printing process can save materials and therefore has greater cost advantages. Using a plurality of nozzles for printing can drastically save time of manufacturing films.

A thickness of the conductive adhesive layer 3 is equal to a thickness of the second substrate 2. Material of the conductive adhesive layer 3 comprises conductive adhesive including silver. A sum of lengths of the second substrate 2 and the conductive adhesive layer 3 is less than a length of the first substrate 1.

The first substrate 1 is an array substrate. The second substrate 2 is a color substrate. A liquid crystal layer (not shown in the figures) is disposed between the first substrate 1 and the second substrate 2.

The present invention also provides a display device comprising the display panel 10 as described above.

Compared to the prior art, advantages of the display device provided by the present invention embodiment are the same as those of the display panel 10 as described above and will not be repeatedly described herein.

The display device provided by the above embodiment can be a product or component with display functions such as a mobile phone, a tablet, a television, a display, a laptop, a digital photo frame, or a navigator.

Advantages of the present invention are that the provided display panel 10, display device, and manufacturing method for the display panel 10 dispose the conductive adhesive layer under the polarizer 4 to avoid the conductive adhesive layer 3 from contacting the side of the polarization layer 42 to further prevent the injected a silver paste from interfering with the polarizer and causing bubbles before being cured and forming the conductive adhesive layer 3 such that the silver paste is prevented from reacting with and corroding the polarization layer 42. The prevent invention solves the technical issue of contact between the conductive adhesive layer 3 and the side of the polarizer 4 causing failure of the polarizer 4 and guarantees a yield rate of products.

Furthermore, it should be noted that in some alternative embodiments, the steps of all the methods can be implemented without an order. For example, two sequential steps can be implemented substantially at the same time, or can be implemented in a reverse sequence.

The above is only preferred embodiments of the present invention. It should be noted that a person of ordinary skill in the art can make several improvements and modifications without departing from the principle of the present invention. These improvements and modifications should also be considered to be within the scope of protection of the present invention.

What is claimed is:

1. A display panel, comprising:
a first substrate;
a second substrate disposed on the first substrate;
a conductive adhesive layer disposed on the first substrate, and located adjacent to the second substrate; and
a polarizer disposed on the second substrate and the conductive adhesive layer.

2. The display panel as claimed in claim 1, wherein a thickness of the conductive adhesive layer is equal to a thickness of the second substrate.

3. The display panel as claimed in claim 1, wherein a sum of lengths of the second substrate and the conductive adhesive layer is less than a length of the first substrate.

4. The display panel as claimed in claim 1, wherein material of the conductive adhesive layer comprises conductive adhesive including silver.

5. The display panel as claimed in claim 1, wherein the polarizer completely covers the second substrate and the conductive adhesive layer.

6. The display panel as claimed in claim 1, wherein the polarizer comprises:
a lower protective layer; and
a polarization layer disposed on the lower protective layer.

7. The display panel as claimed in claim 6, wherein the polarizer further comprises:
an upper protective layer disposed on the polarization layer.

8. A display panel manufacturing method, comprising steps as follows:
providing a first substrate, a second substrate, and a polarizer;
disposing the second substrate on the first substrate;
attaching the polarizer on the second substrate and the conductive adhesive layer; and
injecting a silver paste on the first substrate and on a side of the second substrate, wherein the silver paste is cured to form a conductive adhesive layer.

9. The display panel manufacturing method as claimed in claim 8, wherein the conductive adhesive is made by a nozzle-printing process or an ink-printing process.

10. A display device, comprising the display panel as claimed in claim 1.
